(19) United States
(12) Patent Application Publication
(10) Pub. No.: US 2019/0274302 A1
(43) Pub. Date: Sep. 12, 2019

(54) COMPOSITIONS FOR ACTIVE TREATING AND PREVENTING PLANT DISEASES

(71) Applicants: Chih-Cheng Tai, Campbell, CA (US); Kevin Khoa Anh Le, San Jose, CA (US)

(72) Inventors: Chih-Cheng Tai, Campbell, CA (US); Kevin Khoa Anh Le, San Jose, CA (US)

(21) Appl. No.: 16/297,649

(22) Filed: Mar. 9, 2019

Related U.S. Application Data
(60) Provisional application No. 62/641,062, filed on Mar. 9, 2018.

(51) Int. Cl. A01N 37/06; A01N 25/30; A01N 25/00; A01N 25/02; A01N 37/10; A01N 59/08

(52) U.S. Cl. CPC A01N 37/06; A01N 25/30; A01N 59/08; A01N 25/02; A01N 37/10; A01N 25/002

(57) ABSTRACT

Compositions contain anti-microbial agents that can kill, inhibit, and/or prevent the growth of the microbes. The composition contains carrier and/or retainer forms a protective barrier on the surface of the plants when the composition is applied onto the plants. The carrier forms one or more layers of bio-barrier, which serves as a protective layer preventing microbes and/or other harmful microorganisms or virus from contacting and infecting the plants. The retainer serves as a chemical glue (e.g., a water soluble glue) for increasing the contact time and contact numbers between the anti-microbial agents and the harmful microbes. The compositions are all made from ingredients that are from food-grade, organic, or GRAS (Generally Recognized as Safe) materials under 21 C.F.R. 174-178 (C.F.R.: U.S. Code of Federal Regulations).

### CROSS-REFERENCE TO RELATED APPLICATION(S)

The present invention claims priority to the U.S. provisional patent application Ser. No. 62/641,062, titled “COMPOSITIONS FOR ACTIVE TREATING AND PREVENTING PLANT DISEASES,” filed on Mar. 9, 2018, which is incorporated by reference in its entirety for all purposes.

### FIELD OF INVENTION

The present invention relates to chemical compositions for and methods of treating/preventing plant diseases. Specifically, the present invention relates to antimicrobial agents.

### BACKGROUND OF THE INVENTION

Microbial infections can cause severe damages to the plants. Effective compositions are needed for preventing and active treating microbial infection to the plants.

### SUMMARY OF THE INVENTION

Compositions containing anti-microbial agents that kill, inhibit, and/or prevent the growth of the microbes. In some embodiments, the compositions contain retainer forms a protective barrier on the surface of the plants when the composition is applied onto the plants. In some embodiments, the retainer (e.g., delivery substance) forms one or more layers of bio-protective layer/bio-film, which serves as a protective layer preventing microbes and/or other harmful microorganisms or virus from contacting and infecting the plants.

In some embodiments, the retainer serves as a chemical glue (e.g., a water soluble glue) for increasing the contact time, contact frequency, and total contact numbers by keeping/enclosing the anti-microbial agents with the harmful microbes in a close proximity/enclosed encapsulation.

In an aspect, a food grade plant treating solution comprises water, one or more food grade anti-microbial compositions, a food grade protective layer forming substance (e.g., retainer), and a food grade oxidizing agent. In some embodiments, the one or more food grade anti-microbial compositions comprise a first weak organic acid different from a second weak organic acid. In other embodiments, the first weak organic acid has a pH between 3.2-3.3 at a concentration of 1 mM.

In some other embodiments, the second weak organic acid has a pH between 3.5-3.7 at a concentration of 1 mM. In some embodiments, the first and second weak organic acids comprise a citric acid, a sorbic acid, a benzoic acid, a lactic acid, an ascorbic acid, a salicylic acid, or a combination thereof. In other embodiments, the first and second weak organic acids is selected from two of the following group: a citric acid, a sorbic acid, a benzoic acid, a lactic acid, an ascorbic acid, and a salicylic acid.

In some other embodiments, the one or more food grade anti-microbial compositions comprise at least two organic acids and at least two inorganic compounds. In some embodiments, the at least two inorganic compounds comprise a sodium benzoate, a sodium chloride, a calcium benzoate, a calcium carbonate, a calcium chloride, a sodium carbonate, or a combination thereof. In other embodiments, the at least two inorganic compounds comprise at least one calcium containing compound for a calcification reaction. In some other embodiments, the food grade protective layer forming substance comprises a guar gum, a xanthan gum, a polysaccharide, or a starch. In some embodiments, the food grade protective layer forming substance comprises one or more dextrins. In other embodiments, the food grade oxidizing agent comprises sodium percarbonate or hydrogen peroxide.

In another aspect, a method of treating a plant comprises forming a layer of protective barrier over a surface of a plant by applying an amount of a food grade plant treating solution, filling one or more pores on the surface of a plant by using one or more calcifying substances in the layer of the protective barrier, and inhibiting or preventing a growth of microorganisms on the plant by using one or more food grade anti-microbial substance.

In some embodiments, the method comprises using an oxidizing agent for inhibiting the growth of the microorganisms. In other embodiments, the food grade plant treating solution comprises a guar gum, a xanthan gum, a polysaccharide, a starch, a dextrin, or a combination thereof. In some other embodiments, the food grade calcifying substances, comprise a calcium chloride, a calcium carbonate, or a combination thereof. In some embodiments, the food grade anti-microbial substance comprise at least two organic acids and at least two inorganic compounds.

In other embodiments, the at least two organic acids comprise a citric acid, a sorbic acid, a benzoic acid, a lactic acid, an ascorbic acid, a salicylic acid, or a combination thereof. In some embodiments, the at least two inorganic compounds comprise a sodium benzoate, a calcium benzoate, a calcium carbonate, a calcium chloride, a sodium carbonate, or a combination thereof.

In another aspect, a method of treating a plant comprises forming a layer of protective barrier over a surface of a plant by applying an amount of a food grade plant treating solution, and inhibiting or preventing a growth of microorganisms on the plant by using one or more food grade anti-microbial substance, wherein the food grade anti-microbial substance contains a first organic acid having a pH between 3.2-3.3 at a concentration of 1 mM, a second organic acid having a pH between 3.5-3.7 at a concentration of 1 mM, an oxidizing agent, and one or more inorganic compounds. In some embodiments, the method further comprises filling one or more pores on the surface of a plant by using one or more calcifying substances in the layer of the protective barrier. In other embodiments, the food grade plant treating solution comprises a guar gum, a xanthan gum, a polysaccharide, a starch, a dextrin, or a combination thereof.

In an aspect, a method of treating a plant comprises applying an amount of a plant treating solution to a surface of a plant, wherein the plant treating solution contains one or more anti-microbial agents and a retainer and forming a protective layer over the surface. In some embodiments, the anti-microbial agent contains an antiseptic agent. In other embodiments, the antiseptic agent comprises an amount of organic acid. In some other embodiments, the antiseptic agent comprises an amount of organic acid and an amount of ionic compound.

In some embodiments, a weight ratio of organic acid to the ionic compound is in a range between 1/7 to 1/10. In other embodiments, the anti-microbial agent contains a bactericidal agent. In some other embodiments, the bactericidal agent contains an oxidizer. In some embodiments, the bactericidal agent contains a free radical. In some other embodiments, the protective layer comprises a bio-barrier. In some embodiments, the method further comprises encapsulating a leaf of the plant using the bio-barrier or retainer (e.g., plant protective layer forming substance). In other embodiments, the method further comprises forming a layer of bio-barrier using a water soluble glue.

In another aspect, a plant treating composition comprises an amount of anti-microbial agent, a retainer (a bio-barrier generating substance) capable of forming a layer of bio-barrier when applied on a surface of a plant and capable of retaining the amount of anti-microbial agent, such that the anti-microbial agent is retained for an extended duration to react with an amount of microorganisms on the plant. In some embodiments, the anti-microbial agent contains a bacteriostatic agent. In other embodiments, the anti-microbial agent comprises an amount of organic acid.

In some other embodiments, the anti-microbial agent comprises an amount of organic acid and an amount of ionic substance. In some embodiments, a weight ratio of organic acid to the ionic compound is in a range between 1/7 to 1/10. In some other embodiments, the anti-microbial agent contains a bactericidal agent. In some embodiments, the bactericidal agent contains an oxidizer. In some other embodiments, the bactericidal agent contains a free radical.

In some embodiments, the retainer comprises a water soluble glue.

In another aspect, a method of treating a plant comprises forming a plant disease treatment solution, applying the solution on a surface of a plant, and encapsulating the surface of the plant by forming a bio-barrier, wherein the bio-barrier contains a composition that makes the encapsulation last more than 2 weeks. In some embodiments, the disease treatment solution contains one or more antimicrobial agents. In other embodiments, the one or more antimicrobial agents contains a bactericidal agent and a bacteriostatic agent. In some other embodiments, the bactericidal agent kills microorganisms on the plant when the bactericidal agent is in contact with the microorganisms. In some embodiments, the bacteriostatic agent inhibits or reduces the growth of the microorganisms. In some other embodiments, the bacteriostatic agent generates radicals.

### BRIEF DESCRIPTION OF THE DRAWINGS

FIG. 1 illustrates a method of treating/preventing a plant disease in accordance with some embodiments.

FIG. 2 illustrates a plant disease treating and preventing composition in accordance with some embodiments.

FIG. 2A a method of making a plant treating solution in accordance with some embodiments.

FIG. 3 illustrates a method of making a plant treating solution in accordance with some embodiments.

FIG. 4 illustrates a method of using a plant treating solution in accordance with some embodiments.

FIG. 5 illustrates a plat treating method in accordance with some embodiments.

### DETAILED DESCRIPTION OF THE INVENTION

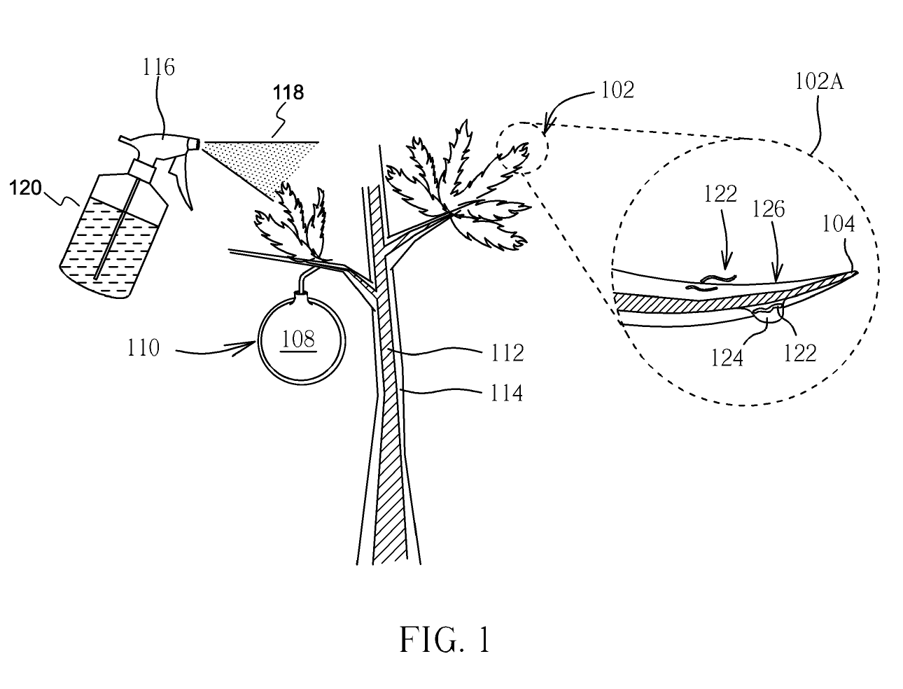

FIG. 1 illustrates a plant disease treating method 100 in accordance with some embodiments. In some embodiments, a plant disease treating solution 120 is prepared. The solution 120 is applied on a plant 112 using an application apparatus 116 (e.g., a sprayer or a spraying bottle). The application of the solution 120 is able to be performed using various methods, including spraying, forming a mist, solution pouring, solution dripping, and solution flowing.

A person of ordinary skill in the art appreciates that any other fluid application methods and forms/types of the fluids are within the scope of the present disclosure, so long as the solution 120 of a predetermined concentration can be applied to cover a predetermined surface of the plant (e.g., an entire pre-selected surface of a plant, (e.g., an entire leaf, an entire fruit, entire plant), a portion of a plant surface (e.g., a portion of a leaf, a portion of a fruit, and a portion of a plant.)) In some embodiments, the predetermined concentration of the solution can be between 1 gram of the chemical composition per liter of water and 10 grams of the chemical composition per liter of water.

In an example, the solution 120 is sprayed using a sprayer, which makes the solution 120 forming a mist 118. The mist 118 covers/encapsulates a surface of the plant. For example, a protective layer or encapsulation layer 110 is formed covering an outside surface of a fruit 108 (e.g., an entire or partial outside surface). Further, a protective layer or encapsulation layer 106 is formed along the outside surface of a leaf 104. The cross-sectional view 102A is a close up view of a leaf 102. Furthermore, a protective layer or encapsulation layer 114 is formed along the outside surface of a plant stem or trunk 112.

In some embodiments, the one or more of the protective layers 106, 110, and 114 (e.g., a retainer) are in a form of one or more layers of bio-protective layer covering/encapsulating at least an area of a plant surface, wherein the bio-protective layer contains an amount of retaining substance, and/or one or more anti-microbial agents. In some embodiments, the retaining substance in a plant treating solution retains the antimicrobial substance on a surface of a plant for at least three days or 2 weeks longer than a plant treating solution without the retaining substance. A person of ordinary skill in the art appreciates that the retaining substance can be selected to have a density, a stickiness, or a type of chemical substance maintain to cover/attach with the applied subject for a predetermined duration.

In some embodiments, the retainer formed protective layer (e.g., a layer of the bio-barrier) forms a barrier having a thickness that prevents a direct contact of 90% or above of external microorganisms with a surface of the plant (e.g., a structure of isolation; a physical barrier), such that the invasion/contact of the microorganisms is prevented or eliminated. In other embodiments, the thickness of the bio-barrier prevents 95% or above of external microorganisms from direct contact with a surface of the plant.

In some other embodiments, the thickness of the bio-barrier prevents 99% or above of external microorganisms from direct contact with a surface of the plant. In some embodiments, the barrier forms a chemical barrier layer. The chemical compositions contained in the barrier chemically reacts with the microorganisms instantly and/or for an extended duration (e.g., up to 2 weeks) when the microorganism is in contact with the barrier. In some embodiments, the barrier forms a physical barrier layer, a chemical barrier layer, or both.

In some embodiments, the protective layer 106 (e.g., the retainer, a glue-like sticky property substance) extends or increases the contact (e.g., reaction) duration, frequency (e.g., keeping the antimicrobial agents in a closer proximity due to a higher fluid density, viscosity, and/or viscoelasticity) and total numbers of contacts of the antimicrobial agent (e.g., bactericidal agents) with the microorganisms 120.

In an exemplary application, the solution 120 has been applied on a surface of a plant that has been infected by microorganisms 122, such that the microorganisms 122 are enclosed/encapsulated therewithin forming an active treating area 124. Within the active treating area 124, the antimicrobial agent (e.g., the bactericidal agents) kills the microorganisms and/or reduces the activity of the microorganisms. The glue-like compositions (e.g., retainer) contained in the active treating area 124 increase the duration, frequency, and/or total encountering numbers of the anti-microbial agents with the microorganisms. The term “microorganism(s)” disclosed herein includes pathogens (e.g., infective organisms), such as organisms that cause infectious diseases including fungi, oomycetes, bacteria, viruses, viroids, virus-like organisms, phytoplasmas, protozoa, nematodes, bugs, worms, and parasitic plants, aphids, powdery mildew, insects, which is also a list that can be treated by using the plant treating solution or composition in powder/solid form in accordance with some embodiments.

In some embodiments, the composition of the protective layer repels ectoparasites like insects, mites (e.g., spider mites), spiders, vertebrate, or other pests that affect plant health by consumption of plant tissues. In some embodiments, the composition of the protective layer repels microorganisms and insects through the acidic substances (e.g., smell of acidic substance) of the acidic ingredients. In some embodiments, the composition of the protective layer repels microorganisms and insects through the pongy smell or malodor of the composition. In some embodiments, the pongy smell/unfavorable smell can be specific to the bugs, but not to human beings.

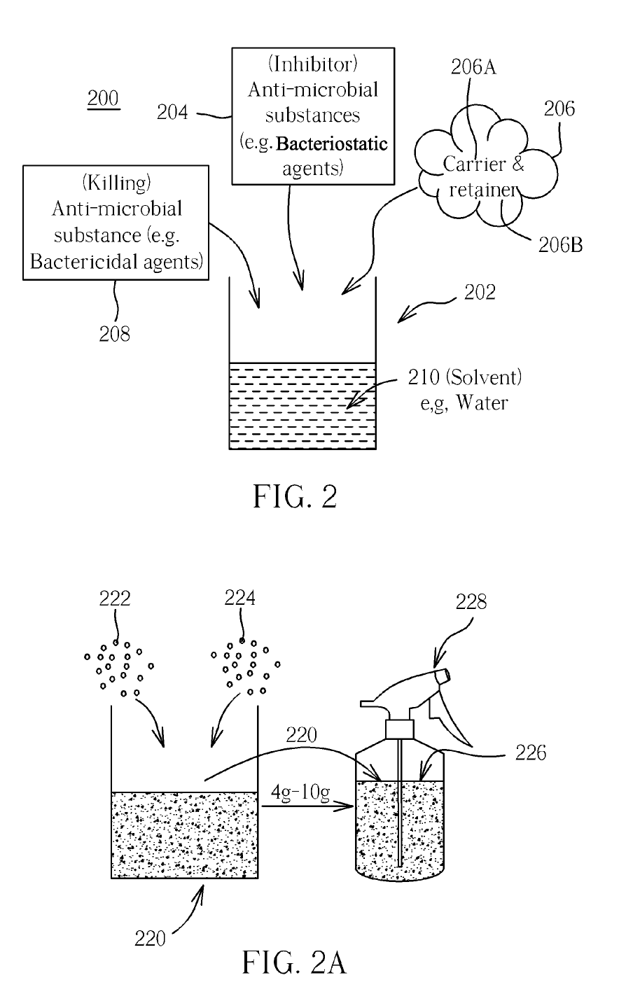

FIG. 2 illustrates a plant disease treating and preventing composition 200 in accordance with some embodiments. The composition 200 can contain active ingredients (e.g., chemical reactive) and non-active ingredients. In some embodiments, the composition 200 is dissolved in a solvent 210 forming a solution 202. In some embodiments, the composition 200 comprises one or more anti-microbial substances 204, 208 and a barrier forming substance 206 (e.g., a retainer).

In some embodiments, the barrier forming substance 206 comprises a carrier 206A, a retainer 206B, or both. In some embodiments, the composition 200 comprises one or more anti-microbial substances 204, 208 and a carrier 206A. In other embodiments, the composition 200 comprises one or more anti-microbial substances 204, 208, a retainer 206B, and a carrier 206A. In some other embodiments, the composition 200 comprises one or more anti-microbial substances and a retainer 206B. The carrier used herein can refers to a substance that helps in delivering the plant disease treating and preventing compositions. In some embodiments, the carrier is an active ingredient. In some embodiments, the carrier is a non-active ingredient. The carrier can be the substrate (e.g., a major part of the composition, such as greater than 50% of the overall composition or the greatest percentage composition among all compositions.)

Anti-Microbial Substances

In some embodiments, the one or more anti-microbial substances comprises a bactericidal agent 208, a bacteriostatic agent 204, or a combination thereof. In some embodiments, the bactericidal agent 208 and/or the bacteriostatic agent 204 comprise an organic acid, an inorganic/ionic acid, or a combination thereof. In some embodiments, the bactericidal agent 208 includes disinfectants, antiseptics, antibiotics, or a combination thereof.

In some embodiments, the anti-microbial substances 204, 208 (e.g., disinfectants agent) include active chlorine (e.g., hypochlorites, chloramines, dichloroisocyanurate and trichloroisocyanurate, wet chlorine, chlorine dioxide and a mixtures thereof); active oxygen (e.g., peroxides, such as peracetic acid, hydrogen peroxide, potassium persulfate, sodium perborate, sodium percarbonate, urea perhydrate and a mixtures thereof); iodine (e.g., povidone-iodine, Lugol's solution, iodine tincture, iodinated nonionic surfactants, and a mixtures thereof); concentrated alcohols (ethanol, 1-propanol/n-propanol, 2-propanol/isopropanol, 2-phenoxyethanol, 1- and 2-phenoxypropanols, and a mixtures thereof); phenolic substances (such as phenol (“carbolic acid”), cresols (e.g., thymol), halogenated (chlorinated, brominated) phenols, such as hexachlorophene, triclosan, trichlorophenol, tribromophenol, pentachlorophenol, salts and isomers thereof); cationic surfactants (e.g., quaternary ammonium cations (such as benzalkonium chloride, cetyl trimethylammonium bromide or chloride, didecyldimethylammonium chloride, cetylpyridinium chloride, benzethonium chloride); non-quaternary compounds (e.g., chlorhexidine, glucoprotamine, octenidine dihydrochloride); strong oxidizers (e.g., ozone and permanganate solutions); heavy metals and their salts (e.g., colloidal silver, silver nitrate, mercury chloride, phenylmercury salts, copper sulfate, copper oxide-chloride); strong acids (phosphoric, nitric, sulfuric, amidosulfuric, toluenesulfonic acids), pH<1, and alkalis (sodium, potassium, calcium hydroxides), such as of pH>13.

In some embodiments, the anti-microbial substances 204, 208 include diluted chlorine preparations (fe. Dakin's solution, 0.5% sodium or potassium hypochlorite solution, pH-adjusted to pH 7-8, or 0.5-1% solution of sodium benzenesulfochloramide (chloramine B)); iodine preparations (e.g., iodopovidone in various galenics (ointment, solutions, wound plasters); peroxides (e.g., hydrogen peroxide, urea perhydrate solutions and pH-buffered 0.1-0.25% peracetic acid solutions); alcohols with or without antiseptic additives; weak organic acids such as citric acid, sorbic acid, benzoic acid, lactic acid, ascorbic acid, and salicylic acid; phenolic compounds (e.g., hexachlorophene, triclosan and Dibromol); sodium percarbonate; sodium benzoate, cationic surfactants, (e.g., 0.05-0.5% benzalkonium, 0.5-4% chlorhexidine, 0.1-2% octenidine solutions).

In some embodiments, the anti-microbial substances 204, 208 include substances that inhibit cell wall synthesis (e.g., the beta-lactam antibiotics (penicillin derivatives (penams), cephalosporins (cephems), monobactams, and carbapenems) and vancomycin). In some embodiments, the one or more anti-microbial substances 204, 208 comprise one or more organic acids and one or more inorganic substances/compounds (e.g., inorganic anti-microbial sub stance).

In some embodiments, the one or more organic acids comprise a formic acid, an acetic acid, a carbonic acid, a uric acid, a citric acid, a malic acid, a benzoic acid, sorbic acid, lactic acid, ascorbic acid, and salicylic acid or a combination thereof. In some embodiments, the one or more inorganic substances comprise sodium benzoate, hydrogen peroxide, sodium percarbonate, calcium chloride, calcium carbonate, or a combination thereof. In some embodiments, the one or more inorganic substances comprise an anti-yeast and/or anti-mold substances, such as sodium benzoate.

In some embodiments, the anti-microbial substances 204, 208 comprise an oxidizing agents, including hydrogen peroxide and sodium percarbonate (e.g., an adduct of sodium carbonate and hydrogen peroxide.) In some embodiments, the bacteriostatic agent 204 includes chloramphenicol, clindamycin, ethambutol, lincosamides, macrolides, nitrofurantoin, novobiocin, oxazolidinone, spectinomycin, sulfonamides, tetracyclines, tigecycline, trimethoprim, or a combination thereof.

In some embodiments, the retainer 206B comprises one or more water soluble glues or water-based adhesives. In some embodiments, the retainer 206B comprises a natural polymer, a soluble synthetic polymers, polysaccharide based polymer, or a combination thereof. The natural polymer can be extracted, isolated, or obtained from a vegetable source (e.g., dextrins (such as, tapioca dextrin and maltodextrin) and starches), a protein source (e.g., casein, blood, fish, soybean, milk albumen), or an animal source (hides, bones). The water soluble synthetic polymers are able to be from polymers including polyvinyl alcohol, cellulose ethers, methylcellulose, carboxymethylcellulose, and polyvinylpyrolidone. Any other substances that can increase the reactivity, the duration, the frequency, and total react numbers between the anti-microbial and the microorganisms when applied on a subject plant are within the scope of the present disclosure.

In some embodiments, the retainer 206B comprises a polysaccharide and/or water soluble fiber. In some embodiments, the carrier 206B comprises cornstarch, guar gum, xanthan gum, topioca dextrin, and starch. Any substances that can increase the viscosity of the solution suitable to form a protective layer (e.g., can remain/effective as a protective layer for more than 1 week when applied on a plant) and safe for human/animal consumption or contacts are within the scope of the present disclosure.

FIG. 2A a method of making a plant treating solution 200A in accordance with some embodiments. In some embodiments, the plant treating solution 200A is formed by adding a plant treating composition 220 into a solvent 226 (e.g., water). In some embodiments, the plant treating composition 220 is dispersed in the solvent 226. In some embodiments, the plant treating composition is completely dissolved in the solvent. In some embodiments, the plant treating composition is partly dispersed and partly dissolved in the solvent. In some embodiments, 4 g-10 g of the plant treating composition is dissolved in 990 g-910 g of water making a 1 L plant treating solution 230.

In some embodiments, the plant treating composition 220 comprises an active ingredient portion 224 and a delivery portion 222. In some embodiments, plant treating composition 220 comprises the active ingredient portion 224 in a range between 60%-95% (weight percentage) and a delivery portion 222 in a range from 5%-20% (weight percentage). In some embodiments, the active ingredient portion 224 contains one or more ingredients, which contain anti-microbial substances having an antimicrobial effect.

In some embodiments, the ingredients contain a mold/yeast inhibiting substance, an acid providing substance, an oxidizing substance, an ion providing substance, or a combination thereof. In some embodiments, the mold/yeast inhibiting substance (e.g., an anti-microbial substance) comprises a wild grape yeast, sodium benzoate, sorbic acid, sorbic acid coated with 50% of vegetable oil, calcium propionate, or a combination thereof. In some embodiments, the acid providing substance (e.g., an anti-microbial substance) comprises one or more weak organic acids (e.g., citric acid, sorbic acid, benzoic acid, lactic acid, ascorbic acid, and salicylic acid). The one or more of the acid providing substances can be selected to form a combination that one acid is more acidic, which can lead the resulting product having a lower pH, and the other acid has the function to maintain the color of the applied subject.

In some embodiments, the acid is selected based on its disinfection property, such as using a citric acid. In some embodiments, the oxidizing substance (e.g., an anti-microbial substance) comprises sodium percarbonate, hydrogen peroxide, or any other peroxides. In some embodiments, the ion providing substance (e.g., inorganic substance) comprises one or more calcifying substances, such as calcium chloride and calcium carbonate. In some embodiments, the ion providing substance is able to be a sodium/calcium providing substance. The calcifying substances can fill the pores on the surfaces of the leaves forming additional protections, which can be used as the protective layer forming substance.

In some embodiments, the plant treating composition is formed by selecting one or more of the above disclosed ingredients for making the composition. In some embodiments, the plant treating composition is formed by adding one or more additional ingredients to an ingredient composition selected from the above described ingredients.

In some embodiments, the delivery portion 222 (e.g., retainer) comprises a polysaccharide based substance, guar gum, xanthan gum, and starch. Any other substances are with the scope of the present disclosure, so long as the delivery substance forms a protective/isolation layer when the delivery substance is applied on a part of a plant. In some embodiments, the delivery portion 222 forms a biofilm or a layer of bio-protective layer over a portion of the plant when the delivery portion 222 is applied on the plant. In some embodiments, the plant treating solution having the delivery portion 222 encapsulates a plant when the solution is applied over a portion of the plant. In some embodiments, the delivery portion 222 comprises a surfactant.

In some embodiments, the ingredients' respective weight ratio percentage comprises 100 g of one or more of the mold/yeast inhibiting substances (e.g., a carbonic acid, a citric acid, a malic acid, a benzoic acid, sorbic acid, lactic acid, ascorbic acid, and salicylic acid), 300 g-400 g of one or more of the acid providing substances (e.g., ascorbic acid and salicylic acid), 250 g of one or more of the oxidizing substance (e.g., sodium percarbonate and hydrogen peroxide), 100-200 g of the ion providing substance (e.g., calcium chloride and calcium carbonate).

In some embodiments, the relative weight ratio of the components of the plant treating composition contains 20%-40% of a first organic acid (e.g., a carbonic acid, a citric acid, a malic acid, a benzoic acid, sorbic acid, lactic acid, ascorbic acid, and salicylic acid), 1-10% of a second organic acid (e.g., ascorbic acid and salicylic acid), 10%-25% of one or more of the calcifying reagents (e.g., calcium chloride and calcium carbonate), 5%-20% of the delivery portion, and 15%-30% of an oxidizing substance (e.g., sodium percarbonate and hydrogen peroxide), wherein the above components make a 100% of the composition. The first organic acid is antimicrobial and is a color enhancer, which maintains the color of the object. The second organic acid is lower in its pH value than the first organic acid.

In some embodiments, when a solid composition is prepared, the pH value is in a range of 2.58-4.2. In some embodiments, when a liquid solution is prepared, the pH value become 3.5-5.5 from 2.58-4.2 when it is in its solid form.

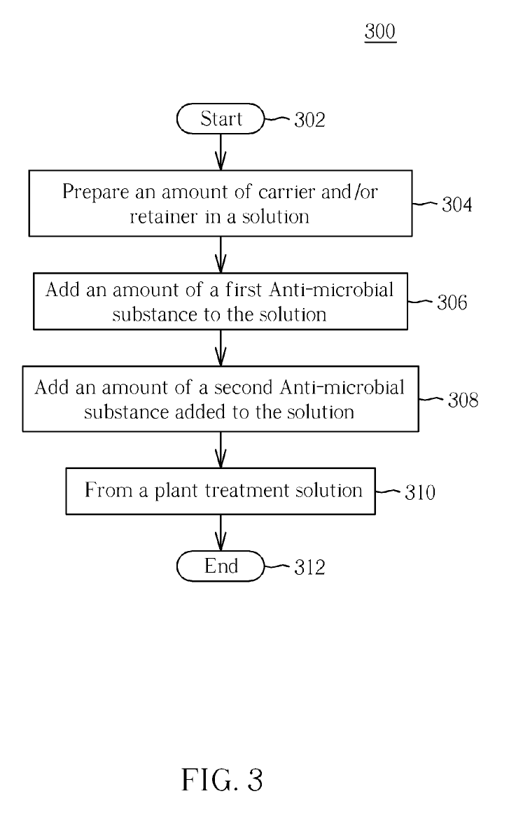

FIG. 3 illustrates a method 300 of making a plant treating solution in accordance with some embodiments. The method 300 starts at a Step 302. At a Step 304, an amount of barrier forming substance (e.g., carrier and/or retainer) are added to a solvent (e.g., water) forming a solution. At a Step 306, an amount of a first type of antimicrobial substance is added to the solution. At a Step 308, an amount of second type of antimicrobial substance is added to the solution. At a Step 310, a plant treating solution is formed. The above steps are exemplary steps, and each of the steps are able to be omitted, skipped, repeated, or added additional steps in some embodiments. In some embodiments, the plant treating solution is used and functioned as a plant protecting solution, which forms a protecting layer and/or encapsulating the plants and parts of the plants (e.g., leaves, buds, fruits, vine, and tree trunk).

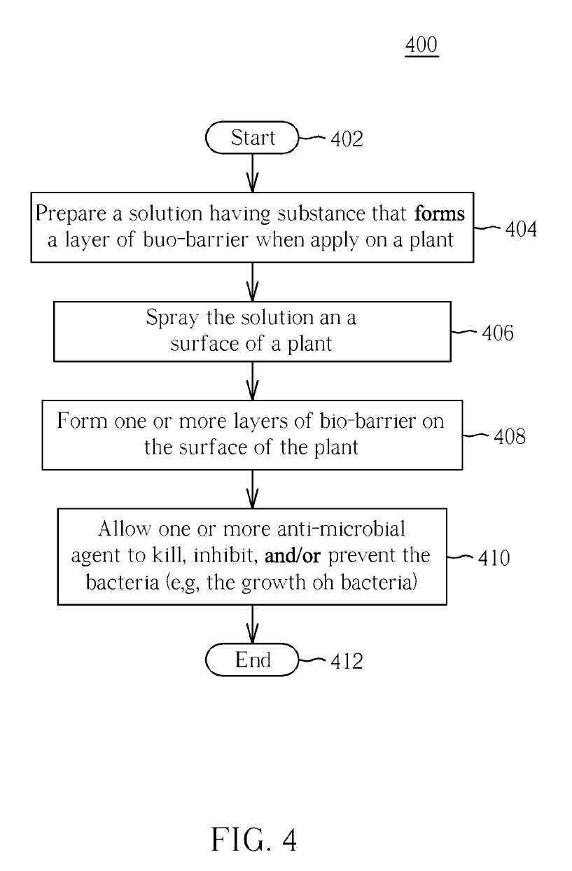

FIG. 4 illustrates a method 400 of using a plant treating solution in accordance with some embodiments. The method 400 starts at Step 402. At a Step 404, a solution is prepared using a substance that forms a layer of bio-barrier/protective layer when applied on a surface of a plant. At a Step 406, the solution is sprayed on a surface of the plant. At a Step 408, one or more layers of bio-barrier/protective layer is formed on the surface of the plant. At a Step 410, one or more anti-microbial agent/substance is used to kill, inhibit, and/or prevent the bacteria and virus from surviving or growing. The method 400 can stop at a Step 412. The plant diseases that are treated and/or prevented using the compositions disclosed herein include the growth of mildew, mold, bugs, and fungi. The compositions disclosed herein also treated citrus greening diseases, and other pathogen infected diseases.

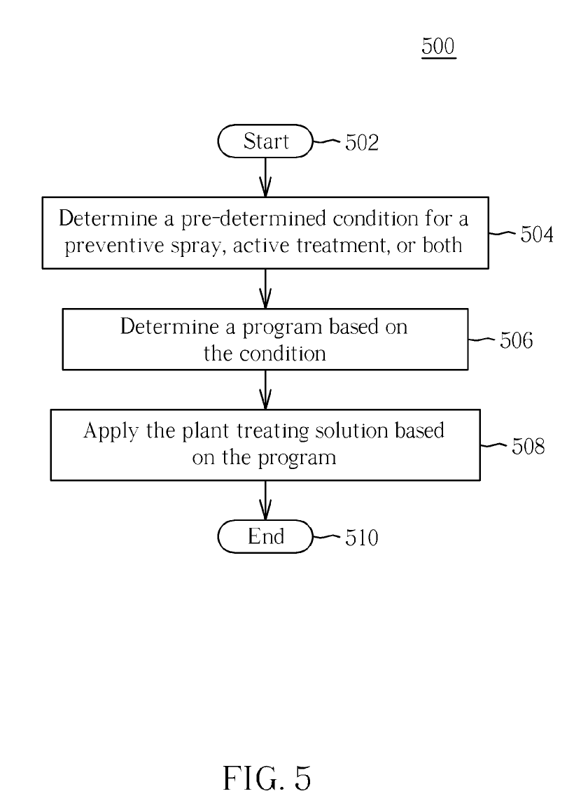

FIG. 5 illustrates a plat treating method 500 in accordance with some embodiments. In some embodiments, the plant treating method is applied for preventive treatment. In other embodiments, the plant treating method is applied for active treatment. In some other embodiments, the plant treating method is applied for preventive and active treatment. The method 500 can start at a Step 502. At a Step 504, a pre-determined condition for an application (e.g., spray) or treatment is determined. The condition includes weather condition, moisture level in the air, signs of infection, or bug infestation in the neighbor area.

In some embodiments, the application of the plant treating solution is performed by using a tunnel sprayer, hand sprayer, a mechanical sprayer, a nozzle sprayer, an atomizer, or any other methods of liquid application. At a Step 506, a treating program based on the condition is determined. At a Step 508, the plant treating solution is applied based on the program. The method 500 can stop at a Step 508. In a preventive spray example, a spray is performed when a weather condition has a higher chance of causing powdery mildew, bacteria diseases, mold, yeast, or a combination thereof. For example, the weather is higher in temperature (e.g., 30° C.) and moisture level (80% humidity). In such weather condition, one or more preventive spray is able to be performed evenly and homogeneously on the subject plants.

Alternatively, a pre-selected area is applied with a higher concentration/density of the plant treating solution than another pre-selected area or non-selected areas. In another example, a spray is performed before rain and/or another spray is performed after rain when a high moisture environment is created. In another preventive spray, a reduced dosage (e.g., 2-4 g of the plant treating composition is dissolved in 1 L of water) is applied on plants as a normal preventive program.

In an active treatment program (when mold is visually detected (at Day 1)), a first spray is applied on the plants. The result shows that the bacteria is removed from the surface of the plants/leaves and the bacteria count is reduced (e.g., the bacteria slows down its multiplication process/numbers). A second spray is applied at Day 3. The result shows that mold stops growing. The application is continued for 3-5 applications. The result shows that the plant treating solution is effective in removing the bacteria from growing on the surface of the plants.

In some embodiments, the solution and composition disclosed herein use all food grade ingredients, including using a benzoate composition. In some other embodiments, the solution and composition disclosed herein qualifies for an organic certificate, including using calcium chloride instead of a benzoate composition. In some embodiments, the plant treating composition and solution are effective in terms of treating, preventing, and/or solving bugs or worms problems (e.g., caterpillar, worms, and spiders). When the solution is sprayed, the solution/mist can attach to wings of bugs, thereby the wings become too heavy to fly. The low pH provided by the solution immobilizes the body of the bugs when the bugs sucks in/drinks the solution. Further, the smell of acidic solution also repels or prevents the worms/bugs from getting close to the plants.

APPLICATION EXAMPLES

### Example 1

A solid mixture has (weight percentage) 10% of ion provider (e.g., calcium chloride, calcium benzoate, and calcium carbonate), 5% of retainer (e.g., guar gum, xanthan gum, and starch), 10% of an organic anti-microbial substances (organic acids, such as citric acid, benzoic acid, lactic acid, ascorbic acid, salicylic acid, and ascorbic acid), and 75% of an inorganic anti-microbial substance (e.g., sodium benzoate). A solution is prepared by adding 1% of the solid mixture, 98% of water, and 1% of hydrogen peroxide.

### Example 2

A solid mixture has 10% of ion provider, 5% of retainer, 10% of an organic anti-microbial substances, and 75% of an inorganic anti-microbial substance. A solution is prepared by adding 1% of the solid mixture, 98% of water, and 1% of sodium percarbonate with tetra acetylethylenediamine (TAED).

### Example 3

A solid mixture has 20% of retainer, 10% of an organic anti-microbial substances, and 70% of an inorganic anti-microbial substance. A solution is prepared by adding 1% of the solid mixture, 98% of water, and 1% of hydrogen peroxide or sodium percarbonate with tetra acetylethylenediamine (TAED).

### Example 4

A solid mixture has 2%-10% of retainer, 1%-20% of an organic anti-microbial substances, and 10%-70% of an inorganic anti-microbial substance. A solution is prepared by adding 1% of the solid mixture, 98% of water, and 1% of hydrogen peroxide or sodium percarbonate with tetra acetylethylenediamine (TAED).

### Example 5

A plant treating solution contains 4-8 g of a composition in 1000 ml of water. The composition comprises a mixture of (weight ratio) 300 g of first weak organic acid, 100 g of a second weak organic acid, 100 g of a first set of inorganic compound(s), 100 g-200 g of a second set of inorganic compound(s), 150 barrier forming substances (e.g., carrier; delivery substance), and 250 g of sodium percarbonate or hydrogen peroxide.

The first and second weak organic acids can be selected from two of the following citric acid, sorbic acid, benzoic acid, lactic acid, ascorbic acid, and salicylic acid, which functions as an antimicrobial agent. In some embodiments, the first and the second organic acids are the same weak organic acid. In some embodiments, the second organic acid (e.g., pH 1.0-2.5) is selected to have a lower pH than the first organic acid (e.g., pH 2.1-3.5 or 2.6-3.4).

The first and second inorganic compounds can be selected from two of the following: sodium benzoate, calcium benzoate, calcium carbonate, sodium carbonate, calcium chloride, sodium chloride or any compound with benzoate/carbonate group. The barrier forming substances can be selected from guar gum, xanthan gum, polysaccharide, and starch.

### Example 6

A solid mixture has (weight percentage) 1%-5% of a retainer, 30%-60% of an organic anti-microbial substance (organic acids, such as citric acid, benzoic acid, lactic acid, ascorbic acid, salicylic acid, and ascorbic acid), and 25%-60% of an inorganic anti-microbial substance (e.g., sodium benzoate). A solution is prepared by adding 1% of the solid mixture, 98% of water, and 1% of hydrogen peroxide. The concentrations of the compositions disclosed herein are examples, and the total percentage of the compositions in each formulation is added to 100%.

### Example 7

A plant treating composition comprises a first food grade organic acid (25% weight percentage), a second food grad organic acid (5%), calcium compounds (30%) [first kind of food grad calcium compound 15% and second kind of food grade calcium compound 15%], and sodium compounds (25%) [first kind of food grad sodium compound 15% and second kind of food grade sodium compound 10%].

### Meaning of the Terms

In some embodiments, the term “Food Grade” or “Food-Grade” includes the ingredients, substances, or materials are fit for human consumption or permitted to come in contact with food. Food Grade used in the present specification includes materials that are as-safe or safer than the Food Grade, including USDA organic, organic certified, and GRAS (Generally Recognized as Safe) for its intended use. In addition in some embodiments, Food Grade also includes materials that complies with the 21 C.F.R. 174-178 of the U.S.

In some embodiments, the term “bacteriostatic” includes an agent that prevents the growth of bacteria/microorganisms (e.g., the substance keeps the bacteria/microorganisms in the stationary phase of growth). In some embodiments, the term “bactericidal” includes an agent that kills bacteria/microorganisms. In some embodiments, the term “microorganism(s)” disclosed herein includes pathogens (e.g., infective organisms), such as organisms that cause infectious diseases including fungi, oomycetes, bacteria, viruses, viroids, virus-like organisms, phytoplasmas, protozoa, nematodes, and parasitic plants. In some embodiments, the composition of the protective layer repeal ectoparasites like insects, mites, vertebrate, or other pests that affect plant health by consumption of plant tissues.

In some embodiments, the term “antiseptic(s)” or “antiseptic substance” disclosed herein include antimicrobial substances that are applied to living tissue/skin to reduce the possibility of infection, sepsis, or putrefaction. In some embodiments, the antiseptics are true germicides, capable of destroying microbes (bacteriocidal), while others are bacteriostatic and only prevent or inhibit their growth. In some embodiments, antibacterials are antiseptics that act against bacteria. In some embodiments, microbicides/anti-microbial destroys virus particles (e.g., viricide and antiviral).

In some embodiments, the carrier comprises a substance at a pre-determined condition (e.g., a predetermined concentration) having a viscosity capable of forming a protective layer over a surface of plant. In some embodiments, the protective layer formed using the plant treating solution is in a form of semi-permeable membrane, which allows the plants to breath while prevents the bugs or microbes from attacking or growing. In some embodiments, the pores on the protective layer is smaller than the bacteria, virus, and/or bugs. In some embodiments, the protective layer (e.g., the ingredient of the plant treating solution) has a more tacky/stickiness/high viscosity, so that the bugs, microbes, and virus can be glued and immobilized.

The plant treating composition/solution is advantageous in that there is no chemical residue on the plant after the solution is applied on plants. The sprayed solution on the plants are washable by water, and no special detergent is needed. Further, no pesticide is used in the composition disclosed. The plant treating composition/solution is stable and can be stored and keep effective for a long time. For example, when the plant treating composition is kept in solid form, the effective duration can last for 10 years. The plant treating solution is adjusted to have a ratio of composition effective for 6 years by having a stable composition and lower in pH (such as a pH lower than 5).

Some pH value of the organic acids disclosed herein are listed below. The pH value disclosed herein can use the pH value provided at the link of http://www.aqion.de/site/192 for reference.

TABLE 1
pH of Some Organic Acids

| | | Alternative | | | |
|---|---|---|---|---|---|
| Formula | Name | name | 1 mM | 10 mM | 100 mM |
| CH₂O₂ | formic acid | methanoic acid | 3.47 | 2.91 | 2.38 |
| C₂H₂O₄ | oxalic acid | ethanedioic | 3.00 | 2.09 | 1.31 |
| | | acid | | | |
| C₂H₄O₂ | acetic acid | ethanoic acid | 3.91 | 3.39 | 2.88 |
| C₃H₄O₄ | malonic acid | propanedioic | 3.17 | 2.50 | 1.94 |
| | | acid | | | |
| C₃H₆O₂ | propanoic | propionic acid | 3.96 | 3.44 | 2.94 |
| | acid | | | | |
| C₃H₆O₃ | lactic acid | milk acid | 3.51 | 2.96 | 2.44 |
| C₄H₆O₅ | malic acid | | 3.33 | 2.74 | 2.21 |
| C₆H₆O | phenol | carbolic acid | 6.47 | 5.99 | 5.49 |
| C₆H₆O₆ | cis-aconitic | | 3.05 | 2.21 | 1.55 |
| | acid | | | | |
| C₆H₆O₆ | trans-aconitic | | 3.14 | 2.48 | 1.92 |
| | acid | | | | |
| C₆H₈O₆ | ascorbic acid | vitamin C | 3.59 | 3.04 | 2.53 |
| C₆H₈O₇ | citric acid | | 3.24 | 2.62 | 2.08 |
| C₇H₆O₂ | benzoic acid | | 3.66 | 3.12 | 2.60 |
| C₇H₆O₃ | salicylic acid | 2-hydroxy- | 3.21 | 2.57 | 2.02 |
| | | benzoic acid | | | |
| C₆H₆O | phenol | carbolic acid | 6.47 | 5.99 | 5.49 |

In some embodiments, each of the chemical compositions of the plant treating solution is food safe of food grade composition. In some examples, the plant treating solution has an unexpected good result when the concentration of the plant treating solution has a concentration between 2 g and 8 g of the plant treating composition per liter of water. When the concentration is lower than the concentration mentioned above, the antimicrobial effect shows only 50% of efficacy due to insufficient wrapping or encapsulating effect to the surface of the plants. When the concentration is higher than the concentration mentioned above, the solution is too sticky and does not apply well. The above mentioned concentration also include having a concentration of a retainer between 0.1 g/L and 0.5 g/L (when retainer is 5% of the composition) or between 0.1 g/L and 1.5 g/L (when the retainer is between 5% and 15% of the composition). Accordingly, the above mentioned concentration shows an unexpected good result of forming idea plant protecting bio-layer or bio-barrier.

In utilization, the methods and devices can be used to treat or prevent a plant disease.

In operation, a plant treating solution is prepared, the solution is applied on to a surface of a plant, and a protective layer is formed over a surface of a plant.

The description is presented to enable one of ordinary skill in the art to make and use the invention. Various modifications to the described embodiments are readily apparent to those persons skilled in the art and the generic principles herein can be applied to other embodiments. Thus, the present invention is not intended to be limited to the embodiments shown but is to be accorded the widest scope consistent with the principles and features described herein. It is readily apparent to one skilled in the art that other modifications can be made to the embodiments without departing from the spirit and scope of the invention as defined by the appended claims.

What is claimed is:

1. A food grade plant treating solution comprises:
a) water;
b) one or more food grade anti-microbial compositions; and
c) a food grade retainer having a concentration capable of forming a food safe protective layer on a plant.

2. The food grade plant treating solution of claim 1, further comprising a food grade oxidizing agent.

3. The food grade plant treating solution of claim 2, wherein the food grade oxidizing agent comprises sodium percarbonate or hydrogen peroxide

4. The food grade plant treating solution of claim 1, wherein the one or more food grade anti-microbial compositions comprise a first weak organic acid different from a second weak organic acid.

5. The food grade plant treating solution of claim 3, wherein the first weak organic acid has a pH between 3.3 and 3.9 at a concentration of 1 mM.

6. The food grade plant treating solution of claim 3, wherein the first weak organic acid comprises formic acid, oxoacetic acid, butanedioic acid, or ascorbic acid.

7. The solution of claim 3, wherein the second weak organic acid has a pH between 2.4 and 3.2 at a concentration of 1 mM.

8. The food grade plant treating solution of claim 3, wherein the second weak organic acid comprises maleic acid, citric acid, or salicylic acid.

9. The solution of claim 2, wherein the first and second weak organic acids comprise a citric acid, a sorbic acid, a benzoic acid, a lactic acid, an ascorbic acid, a salicylic acid, or a combination thereof.

10. The solution of claim 2, wherein the first and second weak organic acids is selected from two of the following group: a citric acid, a sorbic acid, a benzoic acid, a lactic acid, an ascorbic acid, and a salicylic acid.

11. The solution of claim 1, wherein the one or more food grade anti-microbial compositions comprise at least two organic acids and at least two inorganic compounds.

12. The solution of claim 7, wherein the at least two inorganic compounds comprise a sodium benzoate, a sodium chloride, a calcium benzoate, a calcium carbonate, a calcium chloride, a sodium carbonate, or a combination thereof.

13. The solution of claim 7, wherein the at least two inorganic compounds comprise at least one calcium containing compound for a calcification reaction.

14. The solution of claim 7, wherein the food grade retainer comprises a guar gum, a xanthan gum, a polysaccharide, or a starch.

15. The solution of claim 7, wherein the food grade retainer comprises one or more dextrins.

16. The solution of claim 1, wherein the concentration of the retainer is between 0.1 g/L and 0.5 g/L.

17. The solution of claim 1, wherein the concentration of the retainer is between 0.1 g/L and 1.5 g/L.

18. A method of treating a plant comprising:
a) forming a layer of protective barrier over a surface of a plant by applying an amount of a food grade plant treating solution;
b) filling one or more pores on the surface of a plant by using one or more calcifying substances in the layer of the protective barrier, wherein the one or more calcifying substances is in the food grade plant treating solution; and
c) inhibiting or preventing a growth of microorganisms on the plant by using one or more food grade anti-microbial substance in the food grade plant treating solution.

19. The method of claim 18, further comprising using an oxidizing agent for inhibiting the growth of the microorganisms.

20. The method of claim 18, wherein the food grade plant treating solution comprises a guar gum, a xanthan gum, a polysaccharide, a starch, a dextrin, or a combination thereof.

21. The method of claim 18, wherein the food grade calcifying substances, comprise a calcium chloride, a calcium carbonate, or a combination thereof.

22. The method of claim 18, wherein the food grade anti-microbial substance comprise at least two organic acids and at least two inorganic compounds.

23. The method of claim 22, wherein the at least two organic acids comprise a citric acid, a sorbic acid, a benzoic acid, a lactic acid, an ascorbic acid, a salicylic acid, or a combination thereof.

24. The method of claim 22, wherein the at least two inorganic compounds comprise a sodium benzoate, a calcium benzoate, a calcium carbonate, a calcium chloride, a sodium carbonate, or a combination thereof.

25. A method of treating a plant comprising:
a) forming a layer of protective barrier over a surface of a plant by applying an amount of a food grade plant treating solution; and
b) inhibiting or preventing a growth of microorganisms on the plant by using one or more food grade anti-microbial substance, wherein the food grade anti-microbial substance contains a first organic acid having a pH between 3.2-3.3 at a concentration of 1 mM, a second organic acid having a pH between 3.5-3.7 at a concentration of 1 mM, an oxidizing agent, and one or more inorganic compounds.

26. The method of claim 25, further comprising filling one or more pores on the surface of a plant by using one or more calcifying substances in the layer of the protective barrier.

27. The method of claim 25, wherein the food grade plant treating solution comprises a guar gum, a xanthan gum, a polysaccharide, a starch, a dextrin, or a combination thereof.
